(19) United States
(12) Patent Application Publication
(10) Pub. No.: US 2013/0126809 A1
(43) Pub. Date: May 23, 2013

(54) APPARATUS FOR RAISING AND LOWERING A BANNER WITH POWER CORD

(71) Applicants: Paul J. Britten, Traverse City, MI (US); Dale A. Troppman, Traverse City, MI (US)

(72) Inventors: Paul J. Britten, Traverse City, MI (US); Dale A. Troppman, Traverse City, MI (US)

(21) Appl. No.: 13/476,243

(22) Filed: May 21, 2012

Related U.S. Application Data
(60) Provisional application No. 61/489,747, filed on May 25, 2011.

(51) Int. Cl. B66D 1/00

(52) U.S. Cl. CPC B66D 1/00
USPC 254/385

(57) ABSTRACT

An apparatus for raising and lowering an article has a housing and a cable secured to the housing. A motor winds and unwinds the cable on a tube arranged within the housing. A retractable power cord assembly is coupled to the housing. The retractable power cord assembly has a power cord that is wound and unwound from the retractable power cord assembly as the cable is wound and uwound on the tube.

### CROSS-REFERENCE TO RELATED APPLICATIONS

This application claims the benefit of U.S. Provisional Application No. 61/489,747, filed on May 25, 2011. The entire disclosure of the above application is incorporated herein by reference.

### FIELD OF THE INVENTION

The present invention relates to an apparatus for raising and lowering display articles, such as banners, that are hung from high places, such as ceilings in malls, and more particularly, to providing power to or in proximity to the display article.

### BACKGROUND OF THE INVENTION

Banners, posters or other types of display articles are used for textual and/or graphical displays. They are hung in a variety of different places and locations. In one type of application, the display article is hung from a high location, such as the ceiling of a mall or other large facility. A motor driven apparatus may be used to raise and lower the display article. One such apparatus is disclosed in U.S. Pat. No. 7,234,685 for “Apparatus for Raising and Lowering a Banner,” the entire disclosure of which is incorporated herein by reference. This apparatus includes a tube, a motor coupled to the tube, and a plurality of cables that are wound and unwound on the tube by the rotation of the tube by a motor. The cables are attached to the top edge of the display article.

### SUMMARY OF THE INVENTION

An apparatus for raising and lowering an article in accordance with the invention includes a housing, at least one cable secured to the article, a motor that winds and unwinds the cable on a tube arranged within the housing, a retractable power cord assembly coupled to the housing, the retractable power cord assembly having a power cord that is wound and unwound from the retractable power cord assembly, the power cord being wound in the retractable power cord assembly when the cable is wound on the tube and being unwound from the retractable power cord assembly when the cable is being unwound from the tube.

In an aspect of the invention, the power cord has a socket affixed to one end and the power cord is secured to the cable near the socket.

In an aspect, the retractable power cord assembly includes a reel on which the power cord is wound and unwound.

In an aspect, the retractable power cord assembly includes a biasing device that is biased when the power cord is unwound from the reel as the cable is being unwound from the tube and winds the power cord on the reel when the cable is being wound on the tube.

### BRIEF DESCRIPTION OF THE DRAWINGS

The present invention will become more fully understood from the detailed description and the accompanying drawings, wherein:

FIG. 1 is a perspective view of an apparatus in accordance with the disclosure for raising and lowering a display article with a retractable power cord in accordance with an aspect of the present invention;

FIG. 2 is a side perspective view, partially broken away, of the apparatus of FIG. 1 taken along the line 2-2 of FIG. 1;

FIG. 3 is a partial exploded view of a first end of the apparatus of FIG. 1;

FIG. 4 is a partial exploded view of a second end of the apparatus of FIG. 1;

FIG. 5 is a simplified schematic of a prior art switch for controlling the motor of the apparatus of FIG. 1;

FIG. 6 is a simplified schematic of a prior art remote control receiver controlling the motor of the apparatus of FIG. 1 in response to commands from a remote control transmitter; and

FIG. 7 is a simplified schematic of a prior art programmable device controlling the motor of the apparatus of FIG. 1.

### DETAILED DESCRIPTION OF THE PREFERRED EMBODIMENTS

The following description of the preferred embodiment(s) is merely exemplary in nature and is in no way intended to limit the invention, its application, or uses.

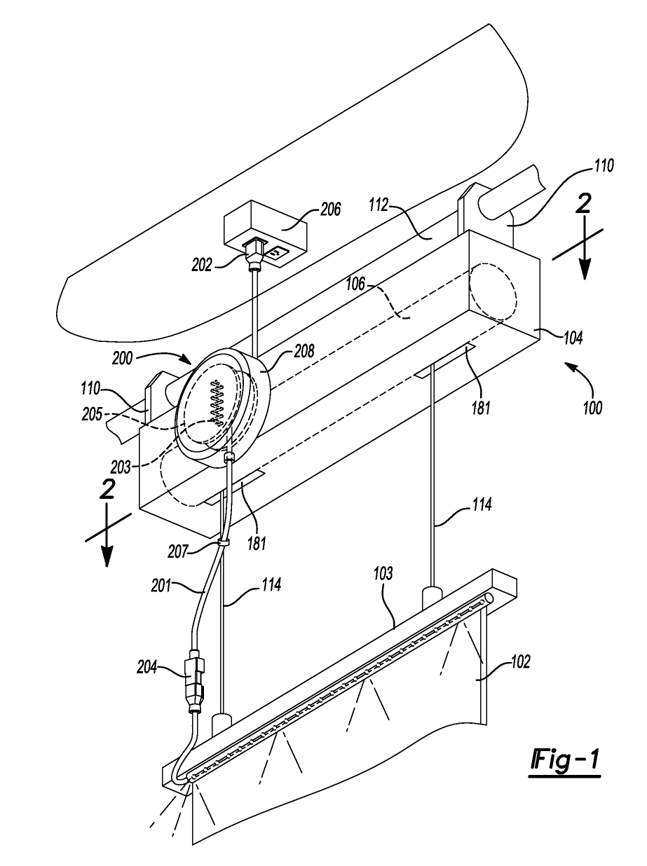

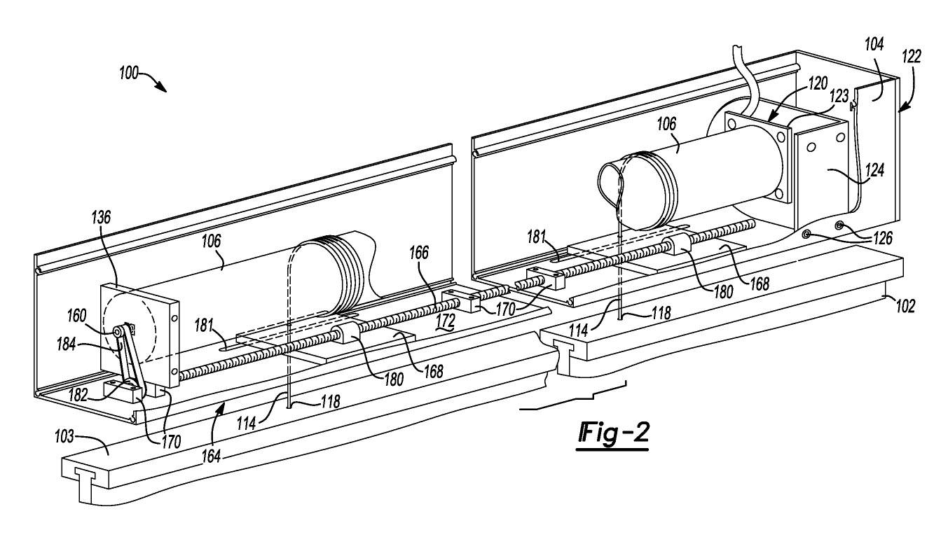

Referring to FIG. 1, an apparatus 100 for raising and lowering a display article 102 with a retractable power cord assembly is shown. Display article 102 can be any type of article that is hung for display, such as banners, that requires power. With reference to FIGS. 1 and 2, apparatus 100 includes a housing 104, which is illustratively a longitudinally extending channel having a rectangular cross-section, and tube 106. Apparatus 100 may also include mounting brackets 110 which attach to an element 112 of the structure to which apparatus 100 is mounted, such as a rod or beam of a ceiling of a facility such as a shopping mall (not shown). It should be understood that apparatus 100 can be attached to the element 112 in other ways than by mounting brackets 110.

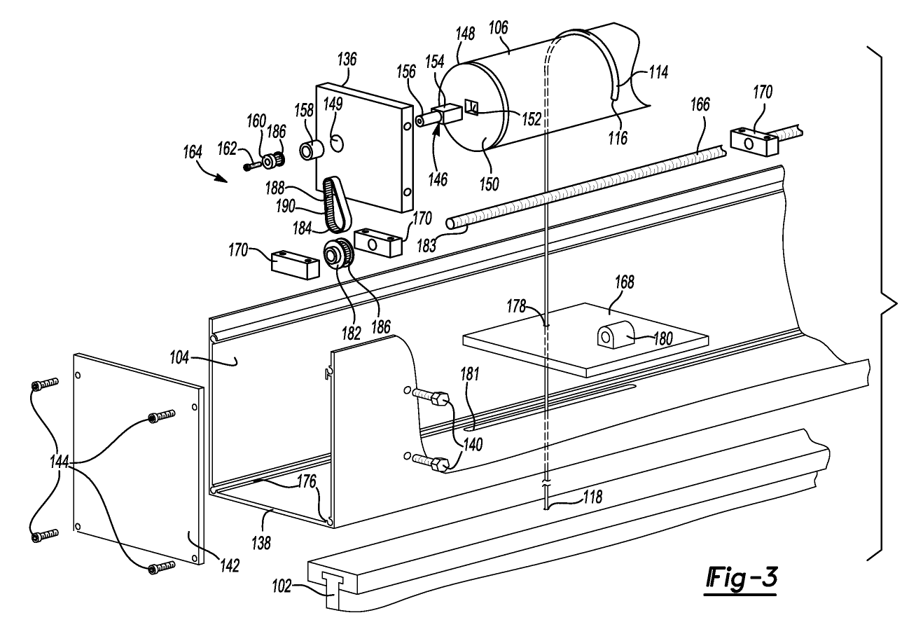

Apparatus 100 further includes one or more lengths of string or cable 114 (which will be collectively referred to as cable 114 herein) having one end 116 (FIG. 3) secured to tube 106. A top edge 103 of display article 102 is secured to the other end 118 of cable 114 (FIG. 2). In the embodiment of apparatus 100 shown in the drawings, apparatus 100 includes two lengths of cable 114 secured to tube 106 in spaced relation to each other. Illustratively, the two lengths of cable 114 are preferably spaced from each other a distance that is about equal to or slightly less than the width of the display article 102. It should be understood, however, that apparatus 100 could have other than two lengths of cable 114. Where more than two lengths of cable 114 are used, the lengths of cable 114 may illustratively be spaced equidistantly from each other within the width of the display article. As used herein, the width of the display article 102 is the width of top edge 103 of display article 102 to which cable(s) 114 are attached.

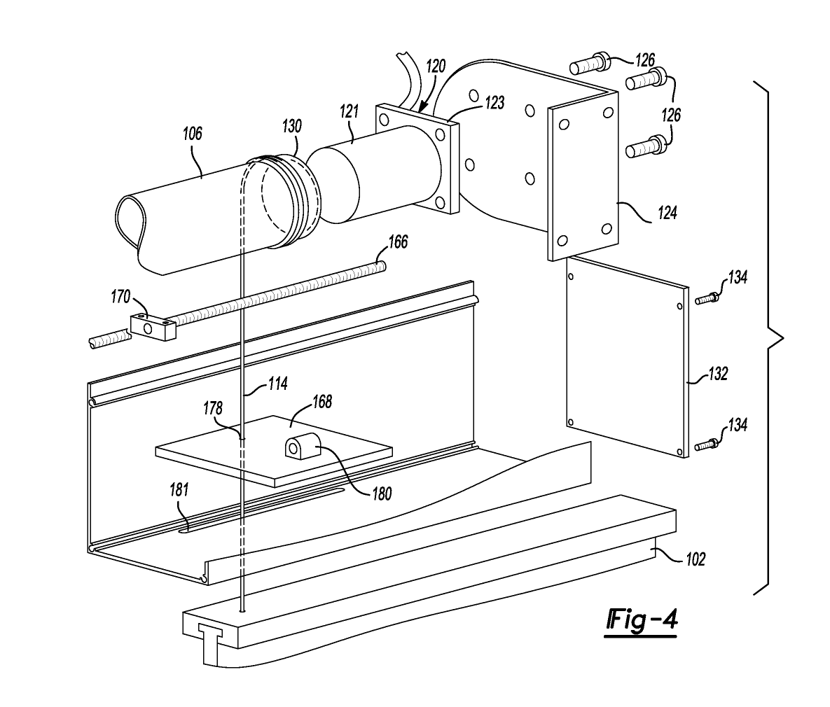

With specific reference to FIG. 4, apparatus 100 also includes a motor 120 to which tube 106 is coupled. Motor 120 is illustratively mounted in housing 104 at a first end 122 (FIG. 2) of housing 104 by attachment to mounting bracket 124, such as with screws 126. Motor 120 may illustratively be a tubular motor, such as a SOMFY LT tubular motor available from SOMFY Systems, 47 Commerce Drive, Cranbury, N.J. 08512. Motor 120 would in such event include a motor 123 to which a tube 121 is attached that fits within a first end 130 of tube 106 and to which tube 106 is secured in conventional fashion, such as with screws, rivets, adhesive, welding, or the like (none of which is shown). An end plate 132 is affixed to the first end 122 of housing 104 such as with screws 134.

With specific reference to FIG. 3, apparatus 100 further includes a second mounting bracket 136 mounted in housing 104 at a second end 138 (FIG. 3) of housing 104, such as with screws 140. An end plate 142 is affixed to the second end 138 of housing 104 such as with screws 144. Tube 106 includes a drive shaft 146 that extends from a second end 148 of tube 106 through a hole 149 in second mounting bracket 136. In this regard, tube 106 may include an end cap 150 affixed to its second end 148 to which drive shaft 146 is affixed, such as by being received and secured in a rectangular hole 152 in end cap 150. In this illustrative embodiment, a first end 154 of drive shaft 146 is rectangular and received in hole 152 and a second end 156 of drive shaft 146, that extends through hole 149 in mounting bracket 136, is cylindrical. A bearing 158 may be received in hole 149 and second end 156 of drive shaft 146 entrained in bearing 158. Second end 156 of drive shaft 146 has a drive wheel 160 secured to it, such as by a screw 162.

Apparatus 100 further includes cable indexer 164 (FIG. 2) that includes lead screw 166 and traveler(s) 168. A traveler as used herein is an element that moves along housing 104 along an axis parallel to a longitudinal axis of tube 106. Lead screw 166 is journalled for rotation in support bearings 170 that are disposed along a bottom wall 172 of housing 104. Apparatus 100 illustratively has a traveler 168 for each cable 114 attached to display article 102. It should be understood, however, that traveler cable indexer 164 could have a single traveler 168 that works with multiple cables 114.

Each traveler 168 is entrained for movement along bottom wall 172 of housing 104. Illustratively traveler 168 comprises a flat rectangular block. It should be understood that structures other than blocks can be used for traveler 168. Housing 104 may include opposed tracks 176 (FIG. 3) in which travelers 168 are entrained. Each traveler 168 further includes an aperture 178 therein at one side thereof through which a respective one of cables 114 passes and a threaded member 180, such as a nut, in which lead screw 166 is threadably received. While aperture 178 is shown a hole extending through traveler 168, it should be understood that traveler 168 could include elements affixed to it, such as opposed fingers, that define aperture 178 or in which aperture 178 is formed. Each traveler 168 is disposed in housing 104 so that its aperture 178 is disposed above a slot 181 in bottom wall 172 of housing 104.

Lead screw 166 has a driven wheel 182 secured at an end 183 beneath the drive wheel 160 that is secured to drive shaft 146. A belt 184 is entrained on wheels 160 and 182. In the embodiment shown, wheels 160, 182 have teeth 186 (FIG. 3) around their periphery and belt 184 has corresponding teeth 188 disposed around an inner side 190 that mate with teeth 186 on wheels 160, 182. It should be understood that other arrangements can be used to couple drive shaft 146 to lead screw 166, such as gears and a chain, a gear train, or the like. In this regard, lead screw 166 is synchronously coupled to tube 106 so that there is no slippage between tube 106 and lead screw 166 when tube 106 rotates to drive lead screw 166 as described below. In the illustrative embodiment described, this synchronization is accomplished by mechanically linking drive shaft 146 to lead screw 166, such as with toothed wheels 160, 182 and toothed belt 184. It should be understood that tube 106 and lead screw 166 could be synchronized in other ways. By way of example and not of limitation, stepper motors could be used to drive both tube 106 and lead screw 166 and the stepper motors electrically synchronized.

In operation, apparatus 100 raises and lowers display article 102 by winding and unwinding cable(s) 114 on tube 106. Motor 120 rotates tube 106 in the appropriate direction to wind and unwind cable(s) 114 on tube 106. As tube 106 rotates, drive shaft 146 drives lead screw 166 via wheels 160, 182 and belt 184 to rotate lead screw 166. The rotation of lead screw 166 in threaded members 180 of travelers 168 of cable indexer 164 causes travelers 168 to travel longitudinally along the bottom wall 172 of housing 104 and thus longitudinally along tube 106. As cables 114 extend through slots 181 in bottom wall 172 of housing 104 and through apertures 178 of travelers 168 of cable indexer 164, each cable 114 is moved longitudinally along tube 106 as it is being wound on tube 106.

With reference to FIG. 1, apparatus 100 includes a retractable power cord assembly 200 having a power cord 201 that has a plug 202 on one end and a socket 204 on another end opposite plug 202. Plug 202 can be coupled to a power source 206, which is illustratively shown as an AC electrical socket in a ceiling but may also be a battery, solar panel or any other conventional power source. Retractable power cord assembly 200 may include a biasing device 203 (shown schematically by spring symbol 203) for winding and unwinding power cord 201. Retractable power cord assembly 200 may also include a reel 205 from which power cord 201 is wound and unwound from, and a case 208 in which power cord 201 is disposed. Retractable power cord assembly 200 may by way of example and not of limitation, be a retractable cord reel available from Bayco, 640 S. Sanden Blvd., Wylie, Tex., with the following modifications. The ratcheting pawl is removed and the wire is replaced with smaller wire, such as 18 gauge lamp wire, which may be silver-clear in color. The smaller gauge wire permits a longer length of wire to be used, such as fifty feet.

Retractable power cord assembly 200 is illustratively mounted on housing 104. In an aspect, power cord 201 may illustratively be secured to cable 114 near its socket 204 by a securing device 207. Securing device 207 may be, by way of example, a clip, a hook, a tie-wrap, or the like.

In operation, apparatus 100 raises and lowers display article 102 by winding and unwinding cable(s) 114 on tube 106. Motor 120 rotates tube 106 in a first direction to wind the cable(s) 114 onto the tube 106 and in a second direction, opposite the first direction to unwind the cable(s) 114 from the tube 106. When apparatus 100 raises and lowers a display article 102, the retractable power cord assembly 200 winds and unwinds power cord 201. As motor 120 rotates tube 106 to unwind cable(s) 114, power cord 201, which is fixedly secured to cable 114 near socket 204, is pulled down or unwound from the retractable power cord assembly 200. As power cord 201 is unwound from reel 205, it pulls on biasing device 203 such as through reel 205, exerting a biasing force on biasing device 203 and biasing the biasing device 203. When motor 120 rotates tube 106 to wind cable(s) 114 on tube 106, the biasing force placed on biasing device 203 by power cord 201 is relaxed causing the biasing device 203 to wind power cord 201 into the retractable power cord assembly 200.

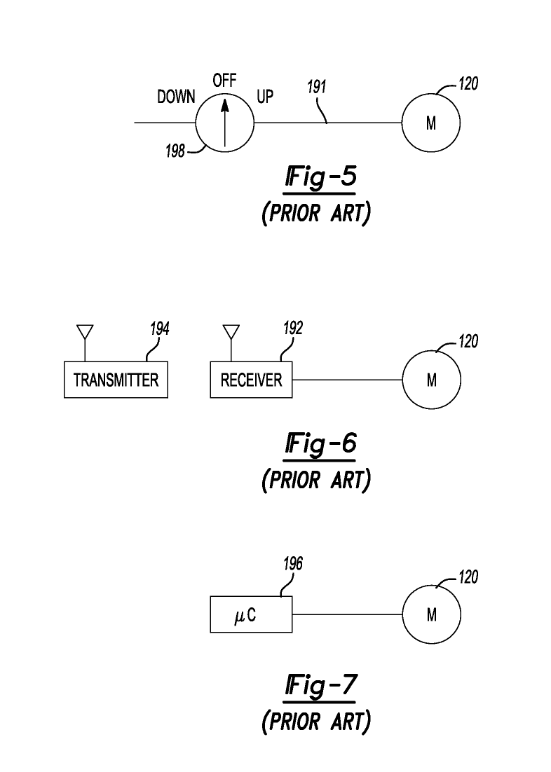

Motor 120 may illustratively be powered by any conventional power source, such as AC, battery or solar panels. Motor 120 may illustratively be turned off by a conventional mechanical switch 198 (FIG. 5), such as may be disposed in the power cord 191 connecting motor 120 to a power source. Apparatus 100 may alternatively or additionally include a remote control receiver 192 (FIG. 6) coupled to motor 120. A user then uses a corresponding transmitter 194 to communicate with the remote control receiver to cause it to energize and de-energize motor 120 in the appropriate directions to wind and unwind cable(s) 114 to raise and lower display article 102. Apparatus 100 may also include a programmable control device 196 (FIG. 7), such as a microcomputer, that is programmed to control motor 120, such as by having pre-sets programmed therein to raise and lower the display article 102 semi-automatically to desired height(s).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for raising and lowering an article, comprising:
a housing;
at least one cable secured to the article;
a motor that winds and unwinds the cable on a tube arranged within the housing; and
a retractable power cord assembly coupled to the housing, the retractable power cord assembly having a power cord that is wound and unwound from the retractable power cord assembly, the power cord being wound in the retractable power cord assembly when the cable is wound on the tube and being unwound from the retractable power cord assembly when the cable is being unwound from the tube.

2. The apparatus of claim 1, wherein the retractable power cord assembly includes a reel on which the power cord is wound and unwound.

3. The apparatus of claim 2 wherein the retractable power cord assembly includes a biasing device that is biased when the power cord is unwound from the reel as the cable is being unwound from the tube and winds the power cord on the reel when the cable is being wound on the tube.

4. The apparatus of claim 1 wherein the power cord has a socket affixed to one end and the power cord is secured to the cable near the socket.
